(19) United States
(12) Patent Application Publication
(10) Pub. No.: US 2012/0143403 A1
(43) Pub. Date: Jun. 7, 2012

(54) INTEGRATED INSIDE MIRROR MODULE

(75) Inventors: Jung Tae Cho, Hwaseong (KR); Suk Young Rho, Anyang (KR); Dae Sung Kim, Hwaseong (KR); Chang Kun Kwon, Daegu (KR); Jeong Hoon Kim, Daegu (KR); Han Taek Lim, Gyeongsan (KR)

(73) Assignees: HYUNDAI MOTOR COMPANY, Seoul (KR); SL CORPORATION, Daegu (KR); KIA MOTORS CORPORATION, Seoul (KR)

(21) Appl. No.: 13/116,288

(22) Filed: May 26, 2011

(30) Foreign Application Priority Data
Dec. 2, 2010 (KR) 10-2010-0121975

(51) Int. Cl. G06F 19/00

(52) U.S. Cl. 701/2

(57) ABSTRACT

The present invention provides an integrated inside mirror module that provides a reduction in the volume of a module package and that reduces manufacturing costs by integrating the individual modules in an inside mirror into one module using an integrated MCU. The integrated inside mirror module includes: an integrated MCU (Main Control Unit) configured to provide an integrated function of a home link controller, an RKE (Remote Keyless Entry) controller, and an ECM (Electronic Chromic Mirror) controller; and an integrated module that is controlled by the integrated MCU, whereinone or more selected from the group consisting of an integrated receiver transmitting a signal received by an integrated antenna to the home link and RKE controller, and an ECM module, are integrated on the same circuit board.

### CROSS-REFERENCE TO RELATED APPLICATION

This application claims under 35 U.S.C. §119(a) the benefit of Korean Patent Application No, 10-2010-0121795 filed Dec. 2, 2010, the entire contents of which are incorporated herein by reference.

### BACKGROUND

(a) Technical Field

The present invention relates to an integrated mirror module, particularly an integrated inside mirror module. More particularly, it relates to an integrated inside mirror module that reduces the volume of a module package and the manufacturing cost by integrating the individual modules mounted in an inside mirror into one module using an integrated MCU.

(b) Background Art

Recently, with the development of various utility devices provided in vehicles, various functional and convenience device modules are being mounted on the inside mirrors of vehicles. Representative utility devices include an ECM (Electronic Chromic Mirror) that automatically adjusts reflection of light from the mirror to prevent a driver from being dazzled by the headlights from other vehicles, and an ETCS (Electronic Toll Collection System) that automatically collects tolls at the tollgate of an expressway.

Recently there have been vehicles provided with a home link system, which is a utility device which opens/closes the door of a garage of a house. Further, there has been an attempt to mount an RKE (Remote Keyless Entry) system in an inside mirror so that locking/unlocking of the vehicle's doors can be controlled from a distance.

With the increase of functional and convenience devices mounted in vehicles, the space inside the vehicles is reduced. To address this problem, there have been attempts to mount new modules within existing vehicle parts, for example, mounting various modules in the housing of an insider mirror.

However, each of these various modules requires an MCU (Main Control Unit), and control elements are mounted on an individual PCB (Printed Circuit Board) to control the system. Thus, it is difficult to add various kinds of modules within an inside mirror, which is limited in size and space.

Further, there is difficulty in individually assembling the modules with the specifications which are adjusted to comply with the options requested by vehicle purchasers. In other words, when a purchaser selects an ECM function and an ETCS, both an ECM PCB and an ETCS PCB must be assembled and connected via interconnectors with wires in the housing of an inside mirror. Further, when an RKE receiving module is added in this configuration, an RKE PCB must be further assembled and connected via an interconnector with a wire, thus providing further complications.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention relates to an integrated inside mirror module that reduces the volume of a module package and reduces the manufacturing cost thereof. In particular, the present invention integrates the individual modules mounted in an inside mirror into a single module using an integrated MCU.

Further, the present invention relates to an integrated inside mirror module that enables simplification of the manufacturing process. In particular, the present invention allows for simple and partial addition/removal of elements of modules integrated on a single PCB, for example, depending on the optional specifications for each class of vehicles.

In one aspect, the present invention provides an integrated inside mirror module including: an integrated MCU (Main Control Unit) providing an integrated function of an ETCS (Electronic Toll Collection System) controller, an RKE (Remote Keyless Entry) controller, and an ECM (Electronic Chromic Mirror) controller; and an integrated module that is controlled by the integrated MCU, and in which any one or more selected from the group of consisting of an ETCS receiver for transmitting a signal received by an ETCS antenna to the ETCS controller, an RKE receiver for transmitting a signal received by an RKE antenna to the RKE controller, and an ECM module, are integrated on the same circuit board.

In another aspect, the present invention provides an integrated inside mirror module including: an integrated MCU for providing an integrated function of a home link controller, an RKE controller, and an ECM controller; and an integrated module that is controlled by the integrated MCU, and in which at least one of an integrated receiver, which transmits a signal received by an integrated antenna to the home link controller and an RKE controller, and an ECM module, is integrated on the same circuit board.

In a preferred embodiment, the integrated MCU controls a home link control for opening/closing the door of a garage in response to RKE locking/unlocking signals received from a user by the integrated antenna.

According to an integrated inside mirror module of the present invention, because individual modules can share an MCU, a power supply, and an antenna, the common parts and elements typically individually required for each module can be removed. Thus, it is possible to further reduce the volume of a module package and the manufacturing cost.

Further, since an integrated module is disposed on a single PCB, it is possible to remove the connectors typically provided between the individual modules. Accordingly, it is possible to reduce the work required for assembling the individual modules, in addition to integrating the individual modules.

Further, since it is possible to simply add or remove desired modules on a platform provided with architecture for the entire module, it is possible to reduce the development time, simplify the manufacturing process, and decrease the development cost.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1 is a view illustrating the configuration of an integrated inside mirror module according to a first embodiment of the present invention;

FIG. 2 is a flowchart illustrating the operation of the integrated inside mirror module according to the first embodiment of the present invention;

FIG. 3 is a timing chart illustrating ECM control and ETCS control which are simultaneously available in traveling, in the integrated inside mirror module according to the first embodiment;

FIG. 4 is a view illustrating the configuration of an integrated inside mirror module according to a second embodiment of the present invention; and

FIG. 5 is a flowchart illustrating the operation of the integrated inside mirror module according to the second embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims. Hereinafter, preferred embodiments of the present invention will be described in detail with reference to the accompanying drawings so that they can be easily carried out by those skilled in the art. While these preferred embodiments illustrate certain aspects of the invention, they are not intended to limit the same.

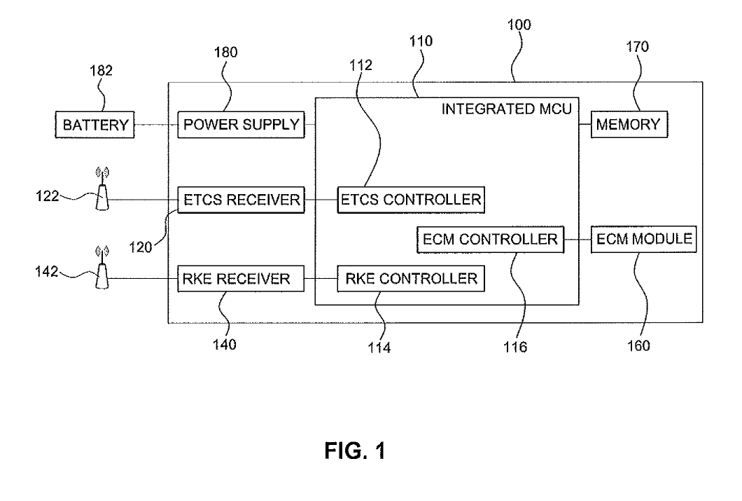

FIG. 1 is a view illustrating an integrated inside mirror module 100 according to a first exemplary embodiment of the present invention.

As shown in FIG. 1, the integrated inside mirror module according to the first embodiment of the present invention may include an integrated MCU (Main Control Unit) 110, an ETCS (Electronic Toll Collection System) receiver 120, an RKE (Remote Keyless Entry) receiver 140, and an ECM (Electronic Chromic Mirror) module 160.

As shown in this embodiment, the integrated MCU 110 may provide an integrated function of an ETCU controller 112, an RKE controller 114, and an ECM controller 116. Thus, a single integrated MCU 110 may be used to control the ETCS module, the RKE module, and the ECM module. Further, the integrated MCU 110, a memory 170, a power supply 180, and controlled modules may be formed on the same circuit board.

The ETCS receiver 120 transmits signals received by an ETCS antenna 122 to the ETCS controller 112 on the integrated MCU 110. Further, the RKE receiver 140 transmits signals received by an RKE antenna 142 to the RKE controller 114 on the integrated MCU 110. In accordance with known ECM modules, the ECM module 160 may include, for example, various sensor circuits (photosensor etc.) for operating the ECM.

The ETCS receiver 120, the RKE receiver 140, and the ECM module 160 may constitute an integrated module that is controlled by the integrated MCU 110. According to various embodiments, only some of the integrated module may be used if desired. Thus, for example, when only some of the configuration of the integrated module is selected by a vehicle purchaser, it is possible to integrate only the circuits for the corresponding modules on the same circuit board and easily remove the non-selected modules.

According to an embodiment of the present invention, the integrated MCU 110 and the integrated module may be integrated as a first controller of the present invention on a first circuit board, while the ETCS antenna 122 and the RKE antenna 142 may be integrated as a communicator of the present invention on a second circuit board. This can, for example, address a limitation in package space. Further, with such a configureation it is possible to prevent electromagnetic interference between the communicator and the controller of the present invention. In alternate embodiments, all of these components (including, for example, the integrated MCU 110, the integrated module, the ETCS antenna 122, and the RKE antenna 142) may be integrated on a single circuit board. Preferably, predetermined distances are maintained between the various components as needed to prevent electromagnetic interference, without a limit in package space.

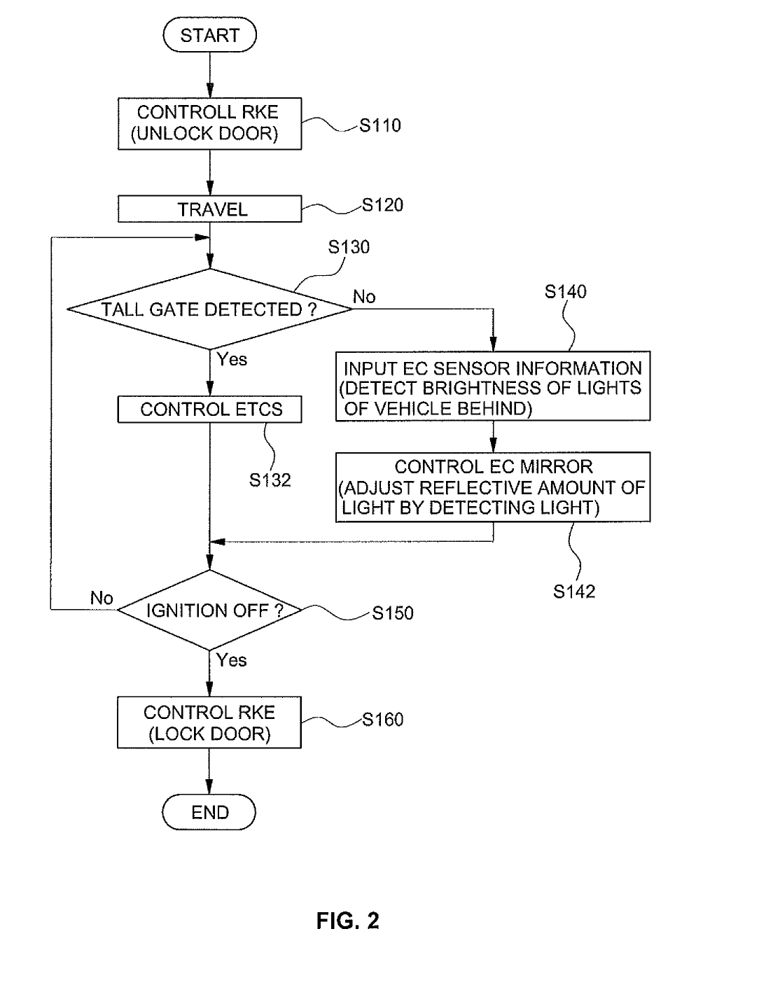

FIG. 2 is a flowchart illustrating the operation of the integrated inside mirror module according to the first embodiment of the present invention as shown in FIG. 1.

The operations of the modules shown in FIG. 2 can be implemented and controlled by the integrated MCU of the present invention. First, when a door-unlocking signal is received by the RKE antenna from a user, the RKE receiver in the integrated inside mirror module of the present invention receives and transmits the signal to the integrated MCU. The integrated MCU transmits the signal to a BCM (Body Control Module) to unlock the door (S110).

Further, when the ETCS antenna receives a natural frequency at a tollgate on an express way (S130) while a vehicle is powered and travels (S120), the ETCS receiver in the integrated inside mirror module of the present invention receives and transmits the signal to the integrated MCU. In this process, an automatic collection management system of the ETCS is operated by the ETCS controller in the integrated MCU (S132).

As further shown, the integrated inside mirror module performs ECM control in real time. That is, the brightness of the headlights of vehicles traveling behind, and preferably further the brightness of ambient light, is sensed by an EC (Electronic Chromic) sensor (S140). The amount of light reflected by the inside mirror is suitably adjusted by transmitting the brightness information to the ECM controller in the integrated MCU (S142).

As shown, these operations may continue until the ignition switch of the vehicle is turned off (S150). When the ignition switch of the vehicle is turned off and a door-locking signal is received by the RKE antenna from a user, the RKE receiver in the integrated inside mirror module of the present invention receives and transmits the signal to the integrated MCU. The integrated MCU transmits the signal to the BCM (Body Control Module) to lock the door (S160).

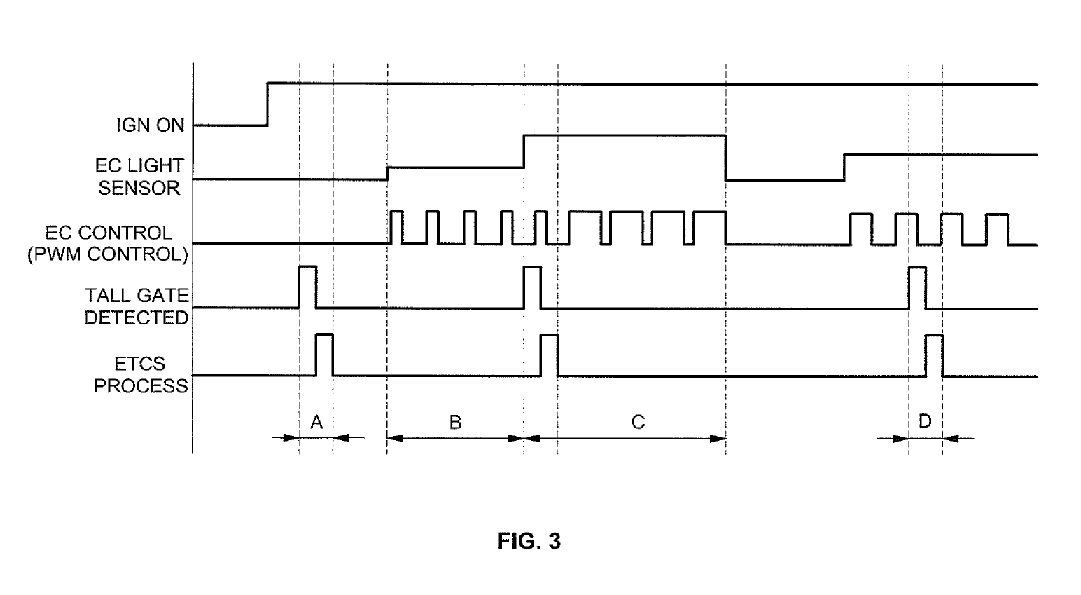

FIG. 3 is a timing chart illustrating ECM control and ETCS control which may occur in traveling, in accordance with the first embodiment of the integrated inside mirror module.

First, the inside mirror module of the present invention can start operating by operating the ignition switch of a vehicle. When a signal from a tollgate is received by the ETCS antenna with the vehicle traveling, the inside mirror module transmits the signal to the integrated MCU to perform ETCU control (‘A’). Further, it senses changes in brightness of light from the outside or the rear, using the EC sensor in traveling, and suitably adjusts ECM reflexibility by outputting PWM voltage (‘B’).

According to various embodiments, the inside mirror module may allow the ETCS control to be performed first in priority, when a signal from a wireless base station at the roadside of a tollgate is received, when adjusting the PWM output according to a change in the amount of sensed light of the ECM. Thus, for example, as shown in the second ‘C’, when the sensed value of the EC sensor changes and a tollgate is sensed by the ETCS at the same time, the PWM output of the ECM controller can be maintained at the previous level, and then after the ETCS control is finished the ECM controller can return to the previous operation and adjust the PWM output voltage according to the sensed value of the EC sensor.

The section ‘D’ also shows a situation when a signal from a wireless base state at the roadside is received while the ECM control is performed. As shown, it is possible to keep the same PWM output and perform the ETCS control without changing the sensed value of the EC sensor.

It is noted that while the first embodiment has been described to include features for an ETCS (Electronic Toll Collection System), an RKE (Remote Keyless Entry), and an ECM (Electronic Chromic Mirror) which are integrated, the present invention is not limited to such combinations, Rather any one or more of these features (e.g. ETCS, RKE, ECM) can be used and, if desired, further additional features with their associated controllers, receivers, etc. can be further added as desired for integration in the single integrated MCU 100.

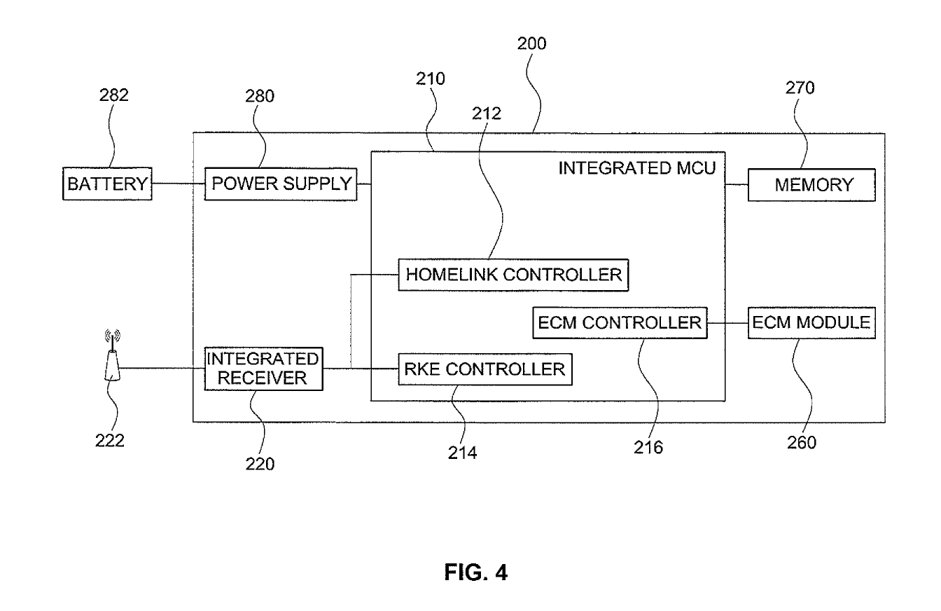

FIG. 4 is a view illustrating an integrated inside mirror module 200 according to a second embodiment of the present invention. The same or similar components as those in the first embodiment shown in FIG. 1 are not further described, but rather, these components can be provided and configured in line with their description in connection with the first embodiment.

As shown in FIG. 4, the integrated inside mirror module 200 according to the second embodiment of the present invention may include an integrated MCU 210, an integrated receiver 220, and an ECM module 260.

As shown in this embodiment, the integrated MCU 210 may provide an integrated function of a home link controller 212, an RKE controller 214, and an ECM controller 216. In particular, a single integrated MCU 210 may be used to control the home link module, the RKE module, and the ECM module while the integrated MCU 210, a memory 270, a power supply 280, and controlled modules may be formed on the same circuit board.

The integrated receiver 220 according to an embodiment of the present invention is provided to transmit signals received by an integrated antenna 222 to the home link controller 212 and the RKE controller 214. The integrated antenna 222 and the integrated receiver 220 may constitute an integrated antenna module of the present invention. Further, the RKE module and the home link module can be controlled by modulation in the same frequency domain, and it is possible to reduce the numbers of antennas and necessary components by using a common integrated antenna module.

The integrated receiver 220 and the ECM module 260 may constitute an integrated module that is controlled by the integrated MCU 210, and as described above, all or portions of the integrated module may be used as desired.

According to an embodiment of the present invention, the integrated MCU 210 and the integrated module may be integrated as a first controller of the present invention on a first circuit board, while the integrated antenna 222 may be integrated as a communicator of the present invention on a second circuit board. In accordance with this arrangement, it is possible to prevent electromagnetic interference between the communicator and the controller of the present invention. In an alternate arrangement, as described above in connection with FIG. 1, all components may be integrated on a single circuit board, preferably wherein electromagnetic interference is prevented by providing suitable predetermined distances between components, without a limit in package space.

According to the integrated inside mirror module according to the second embodiment of the present invention, it is possible to easily perform inter-control between two systems by using an integrated antenna module in which the RKE antenna module and the home link antenna module are integrated. Thus, for example, it is possible to perform locking/unlocking of vehicle doors in synchronization with opening/closing the door of a garage.

For example, when an RKE door-unlocking signal is received through the integrated antenna 222 from a user, the signal can be simultaneously transmitted to the RKE controller 214 and the home link controller 212 through the integrated receiver 220. In this process, the home link controller 212 can perform control for opening the door of a garage in response to the RKE door-unlocking signal. Further, when an RKE door-locking signal is received by the integrated antenna 222 from a user, the signal, similarly, is transmitted to the home link controller 212 such that control for closing the door of a garage can be performed.

Further, according to an embodiment of the present invention it is possible to automatically lock the doors of a vehicle by performing the RKE control, for example when a key has been separated from the key switch and there is no external input signal, such as the RKE control, after the door of a garage is closed by the home link control,

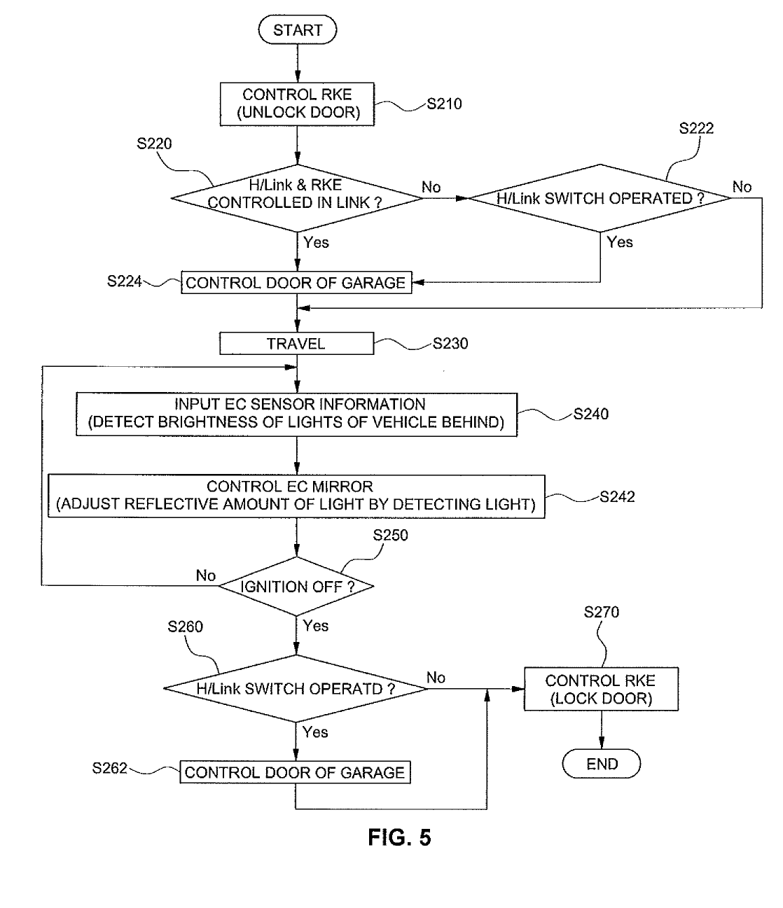

FIG. 5 is a flowchart illustrating the operation of the integrated inside mirror module according to the second embodiment of the present invention.

First, when a door-unlocking signal is received by the RKE antenna from a user, the RKE receiver in the integrated inside mirror module of the present invention receives and transmits the signal to the integrated MCU. The integrated MCU transmits the signal to a BCM (Body Control Module) to unlock the door (S210).

In this operation, according to an embodiment of the present invention wherein the home link (H/Link) and the RKE system are linked with each other (S220), it is possible to perform a control to automatically open the door of the garage (S224). Alternatively, when the home link and the RKE system are not linked, it is possible to open the door of the garage by means of the operation of the home link switch (S222 and S224).

Next, the integrated inside mirror module of the present invention performs the ECM control in real time while the vehicle is powered and travels (S230). In particular, the brightness of the headlights of a vehicle traveling behind, and preferably further the brightness of ambient light, is sensed by an EC (Electronic Chromic) sensor (S240), and it is possible to suitably adjust the amount of light reflected by the inside mirror by transmitting the brightness information to the ECM controller in the integrated MCU (S242).

The operation may continue until the ignition switch of the vehicle is turned off (S250). In this state, it is possible to perform a control for opening/closing the door of the garage (S262), when the user operates the home link switch (S260).

Further, when a door-locking signal is received by the RKE antenna from a user, the integrated receiver of the present invention receives and transmits the signal to the integrated MCU. The integrated MCU transmits the signal to the BCM (Body Control Module) such that the door is locked (S270). In this operation, when the home link and the RKE system are linked with each other, according to an embodiment of the present invention, it is possible to control the door of the garage to be automatically closed.

As noted above in connection with the first embodiment depicted in FIGS. 1 and 2, while this embodiment has been described to include features for a home link mechanism, an RKE, and an ECM which are integrated, the present invention is not limited to such combinations. Rather any one or more of these features (e.g. home link, RKE, ECM) can be used and, if desired, further additional features with their associated controllers, receivers, etc. can be further included as desired for integration in the single integrated MCU 200.

As described above, the present invention can reduce the package space for each system module by integrating the modules, which are equipped the inside mirror, in one module, using one MCU (integrated ECM+RKE+ETCS or integrated ECM+RKE+home link, as well as other possible integrated combinations including one or more of ECM, RKE, ETCS, home link, and other vehicle features). Further, it is possible to reduce the manufacturing cost by reducing the MCU and the circuit board and removing common parts (which are shared in accordance with the present embodiments and, thus, are not individually required for each component) and the connectors, and to reduce the work for assembling the individual modules.

Further, it is possible to standardize the specifications for the grades of vehicles without changing the basic structure by partially adding/removing the modules integrated on one board, in accordance with the options, using an electronic platform concept.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An integrated inside mirror module comprising:
an integrated MCU (Main Control Unit) configured for providing an integrated function of an ETCS (Electronic Toll Collection System) controller, an RKE (Remote Keyless Entry) controller, and an ECM (Electronic Chromic Mirror) controller; and
an integrated module that is controlled by the integrated MCU, wherein one or more selected from the group of consisting of an ETCS receiver for transmitting a signal received by an ETCS antenna to the ETCS controller, an RKE receiver for transmitting a signal received by an RKE antenna to the RKE controller, and an ECM module, are integrated on a single circuit board.

2. An integrated inside mirror module comprising:
an integrated MCU (Main Control Unit) configured for providing an integrated function of a home link controller, an RKE (Remote Keyless Entry) controller, and an ECM (Electronic Chromic Mirror) controller; and
an integrated module that is controlled by the integrated MCU, wherein at least one of an integrated receiver, which is configured to transmit a signal received by an integrated antenna to the home link controller and the RKE controller, and an ECM module, is integrated on a single circuit board.

3. The integrated inside mirror module of claim 2, wherein the integrated MCU controls a home link control for opening/closing the door of a garage in response to RKE locking/unlocking signals received by the integrated antenna from a user.

4. A vehicle comprising the integrated inside mirror module of claim 1 or 2.

5. An inside mirror for a vehicle having disposed therein the integrated inside mirror module of claim 1 or 2.
